(19) United States
(12) Patent Application Publication
(10) Pub. No.: US 2014/0204017 A1
(43) Pub. Date: Jul. 24, 2014

(54) ELECTRONIC DEVICE AND METHOD FOR CONTROLLING ACCESS TO THE ELECTRONIC DEVICE

(71) Applicants: Chiun Mai Communication Systems, Inc., New Taipei (TW); SHENZHEN FUTAIHONG PRECISION INDUSTRY CO., LTD., Shenzhen (CN)

(72) Inventor: CONG WU, Shenzhen (CN)

(73) Assignees: Chiun Mai Communication Systems, Inc., New Taipei (TW); SHENZHEN FUTAIHONG PRECISION INDUSTRY CO., LTD., Shenzhen (CN)

(21) Appl. No.: 14/011,756

(22) Filed: Aug. 28, 2013

(30) Foreign Application Priority Data
Jan. 21, 2013 (CN) 2013100215422

(51) Int. Cl. G06F 3/01

(52) U.S. Cl. CPC G06F 3/011
USPC 345/156

(57) ABSTRACT

A method for controlling access to an electronic device, the electronic device activates a motion sensor to detect movement parameters, of a spatial moving operation of the electronic device, when a display device of the electronic device awakes from a sleep mode. once the movement parameters detected by the motion sensor match predetermined reference parameters, the electronic device is unlocked.

### BACKGROUND

1. Technical Field

Embodiments of the present disclosure relate to access control technology, and particularly to an electronic device and method for controlling access to the electronic device.

2. Description of Related Art

An electronic device (e.g., a mobile phone) may be unlocked using a slide operation on a display device of the electronic device. However, if the display device is too large, it is inconvenient for a user to unlock the electronic device. For example, the user needs to use one hand to hold the electronic device, and use the other hand to execute the slide operation to unlock the electronic device. Therefore, an efficient and simplified method for controlling access to the electronic device is desired.

### BRIEF DESCRIPTION OF THE DRAWINGS

FIG. 1 is a block diagram of one embodiment of an electronic device including an unlocking system.

FIG. 2 is a block diagram of function modules of the unlocking system included in the electronic device of FIG. 1.

FIG. 3 is a flowchart of one embodiment of a method for unlocking the electronic device of FIG. 1.

FIG. 4 is an example of a coordinate system.

### DETAILED DESCRIPTION

All of the processes described below may be embodied in, and fully automated via, functional code modules executed by one or more general purpose electronic devices or processors. The code modules may be stored in any type of non-transitory computer-readable medium or other storage device. Some or all of the methods may alternatively be embodied in specialized hardware. Depending on the embodiment, the non-transitory computer-readable medium may be a hard disk drive, a compact disc, a digital video disc, a tape drive or other suitable storage medium.

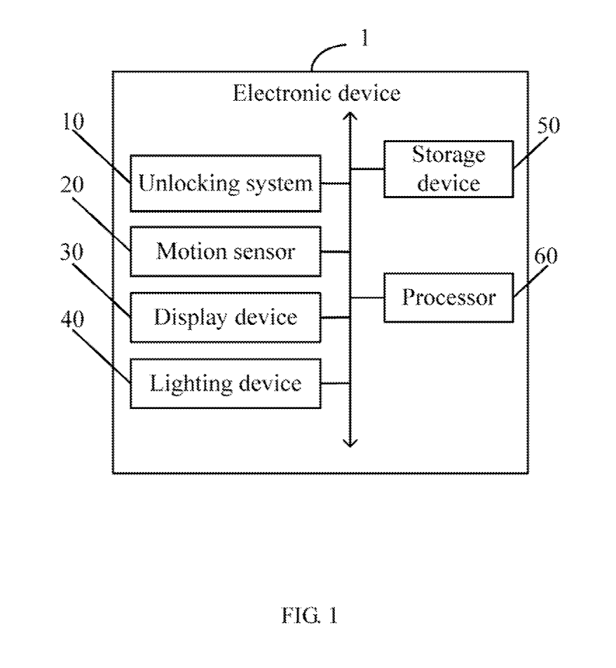

FIG. 1 is a block diagram of one embodiment of an electronic device 1 including an unlocking system 10. The electronic device 1 further includes a motion sensor 20, a display device 30, a lighting device 40, a storage device 50, and at least one processor 60.

The electronic device 1 may be a mobile phone, a personal digital assistant (PDA), or any other computing device. The motion sensor 20 is used to detect movement parameters of a spatial moving operation of the electronic device 1, when the display device 30 awakens from a sleep mode. The spatial moving operation represents a spatial position change of the electronic device 1 from one point to another point based on a coordinate system predetermined by the electronic device 1. The lighting device 40 is used to light the display device 30.

In one embodiment, the motion sensor 20 is a gyroscope, and the movement parameters include rotation angles of the spatial moving operation of the electronic device 1. In other embodiments, the motion sensor 20 can be other kind of sensors such as an accelerometer, and the movement parameters include a distance of the spatial moving operation of the electronic device 1. The unlocking system 10 is used to unlock the electronic device 1, when the movement parameters detected by the motion sensor 20 match predetermined reference parameters. Details will be given in the following paragraphs.

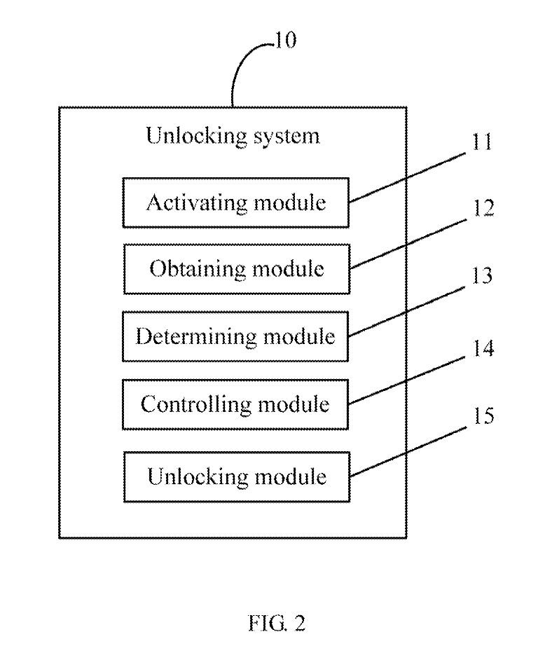

FIG. 2 is a block diagram of function modules of the unlocking system 10 in the electronic device 1. In one embodiment, the unlocking system 10 may include computerized instructions in the form of one or more programs that are executed by the at least one processor 60 and stored in the storage device 50. For example, the unlocking system 10 includes an activating module 11, an obtaining module 12, a determining module 13, a controlling module 14, and an unlocking module 15.

In general, the word “module,” as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable medium include CDs, DVDs, BLU-RAY, flash memory, and hard disk drives.

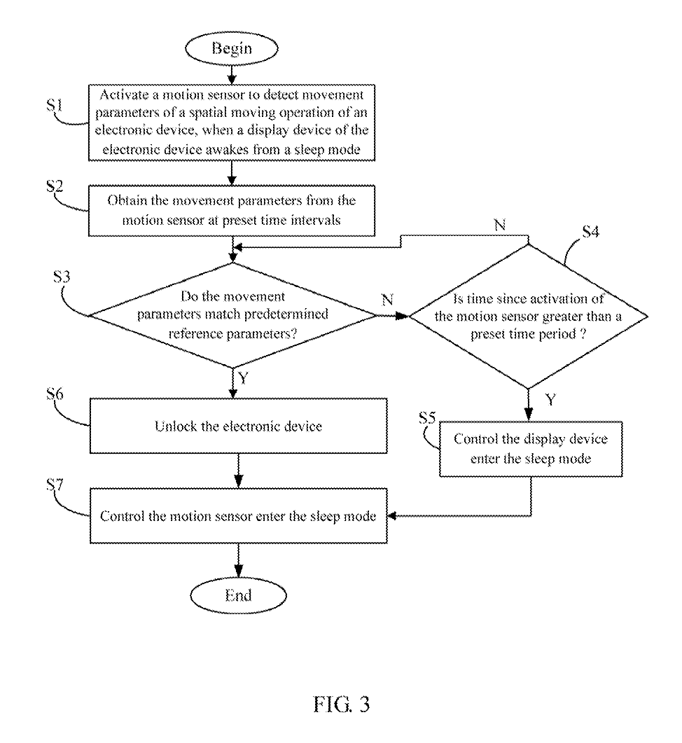

FIG. 3 is a flowchart of one embodiment of a method of unlocking the electronic device 1. Depending on the embodiment, additional steps may be added, others removed, and the ordering of the steps may be changed.

In step S1, the activating module 11 activates the motion sensor 20 to detect movement parameters of a spatial moving operation of the electronic device 1, when the display device 30 awakens from a sleep mode. Depending on the embodiment, when the electronic device 1 is locked, if a user wants to unlock the electronic device 1, the user may presses a power button of the electronic device 1 to turn on the lighting device 40 to light the display device 30. Then, the display device 30 is awaked from the sleep mode.

In this embodiment, the activating module 11 activates the motion sensor 20 through an Inter-Integrated Circuit (I²C) bus of the electronic device 1. In other embodiments, the activating module 11 activates the motion sensor 20 through a Serial Peripheral Interface (SPI) bus of the electronic device 1.

As mentioned above, the spatial moving operation represents a spatial position change of the electronic device 1 from one point to another point based on the coordinate system predetermined by the electronic device 1. When the motion sensor 20 is a gyroscope, and the movement parameters detected by the motion sensor 20 are rotation angles of each axis of the predetermined coordinate system.

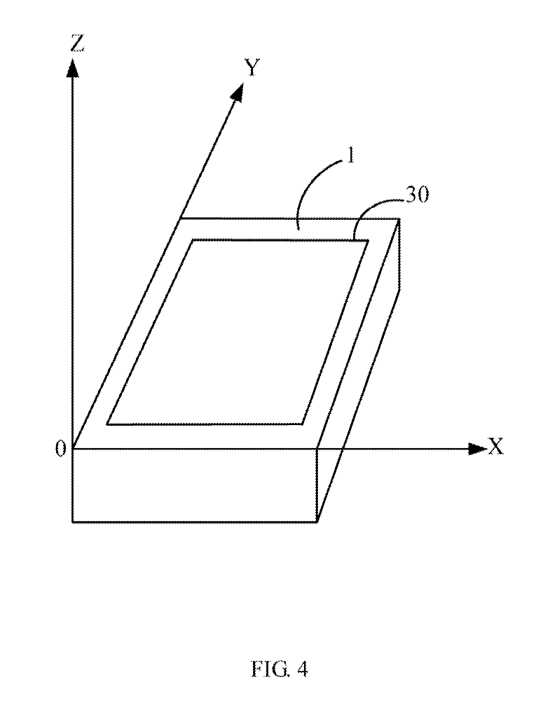

As shown in FIG. 4, in this embodiment, the electronic device 1 predetermines the coordinate system by setting a lower left corner of the display device 30 as an origin of the coordinate system, setting a bottom side of the display device 30 as an X-axis, setting a left side of the display device 30 as a Y-axis, and setting a Z-axis perpendicular to the display device 30 and extending through the origin.

When the motion sensor 20 is an accelerometer, and the movement parameters detected by the motion sensor 20 include a distance between a start point and an end point of a movement path of the electronic device 1. The motion sensor 20 determines the movement path in response to the spatial moving operation of the electronic device 1.

In step S2, the obtaining module 12 obtains the movement parameters from the motion sensor 20 at preset time intervals (e.g., 5 seconds). For example, when the motion sensor 20 is the gyroscope, the obtaining module 12 obtains a first rotation angle of the X-axis, a first rotation angle of the Y-axis, and a first rotation angle of the Z-axis, from the motion sensor 20 at a first time Ts. The obtaining module 12 further obtains a second rotation angle of the X-axis, a second rotation angle of the Y-axis, and a second rotation angle of the Z-axis, from the motion sensor 20 at a second time (T+5)s.

In another example, when the motion sensor 20 is the accelerometer, the obtaining module 12 obtains a first distance from the motion sensor 20 at the first time Ts. The obtaining module 12 further obtains a second distance from the motion sensor 20 at the second time (T+5)s.

In step S3, the determining module 13 determines whether the movement parameters match predetermined reference parameters. If the movement parameters match the predetermined reference parameters, the process goes to step S6. If the movement parameters do not match the predetermined reference parameters, the process goes to step S4.

In a first embodiment, when the motion sensor 20 is a gyroscope, the determining module 13 compares each of the rotation angles with a corresponding predetermined reference angle on the axis of the predetermined coordinate system, and determines that the movement parameters match the predetermined reference parameters when each of the rotation angles is greater than or equal to the corresponding predetermined reference angle.

For example, if the first rotation angle of the X-axis is greater than the predetermined reference angle of the X-axis, and the second rotation angle of the Y-axis is greater that the predetermined reference angle of the Y-axis, the determining module 13 determines that the movement parameters match the predetermined reference parameters.

In a second embodiment, when the motion sensor 20 is the accelerometer, the determining module 13 compares the distance with a predetermined reference distance, and determines that the movement parameters match the predetermined reference parameters when the distance is greater than the predetermined reference distance.

In step S4, the determining module 14 determines whether time since activation of the motion sensor 20 is greater than a preset time period (e.g., 5 minutes).

If the time since activation of the motion sensor 20 is greater than the preset time period, the process goes to step S5, if the time since activation of the motion sensor 20 is not greater than the preset time period, the process returns to step S3.

In step S5, the controlling module 14 controls the display device 30 to enter the sleep mode by disabling the light device 40. When the display device 30 enters into the sleep mode, the process goes to step S7.

In step S6, the unlocking module 15 unlocks the electronic device 1.

In step S7, the controlling module 14 controls the motion sensor 20 to enter the sleep mode.

It should be emphasized that the above-described embodiments of the present disclosure, particularly, any embodiments, are merely possible examples of implementations, set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure is protected by the following claims.

What is claimed is:

1. A computer-implemented method for controlling access to an electronic device being executed by a processor of the electronic device, the electronic device comprising a motion sensor and a display device, the method comprising:
activating the motion sensor to detect movement parameters of a spatial moving operation of the electronic device, when the display device awakes from a sleep mode;
obtaining the movement parameters from the motion sensor at preset time intervals;
determining whether the movement parameters match predetermined reference parameters; and
unlocking the electronic device when the movement parameters match predetermined reference parameters.

2. The method according to claim 1, further comprising:
controlling the display device and the motion sensor to enter the sleep mode, when time since activation of the motion sensor is greater than a preset time period.

3. The method according to claim 1, wherein the motion sensor is a gyroscope sensor, and the movement parameters comprise one or more rotation angles of the electronic device based on a predetermined coordinate system of the electronic device.

4. The method according to claim 3, wherein the step of determining whether the movement parameters match predetermined reference parameters comprises:
comparing each of the one or more rotation angles with a corresponding predetermined reference angle on an axis of the predetermined coordinate system; and
determining that the movement parameters match the predetermined reference parameters when each of the one or more rotation angles is greater than the corresponding predetermined reference angle.

5. The method according to claim 1, wherein the motion sensor is an accelerometer, and the movement parameters comprise a distance between a start point and an end point of a movement path of the electronic device, the movement path being determined in response to the spatial moving operation of the electronic device.

6. The method according to claim 5, wherein the step of determining whether the movement parameters match predetermined reference parameters comprises:
comparing the distance with a predetermined reference distance; and
determining that the movement parameters match the predetermined reference parameters when the distance is greater than the predetermined reference distance.

7. An electronic device, comprising:
a motion sensor;
a display device; and
at least one processor;
a storage device storing a plurality of instructions, which when executed by the at least one processor, causes the processor to:
activate the motion sensor to detect movement parameters of a spatial moving operation of the electronic device, when the display device awakes from a sleep mode;
obtain the movement parameters from the motion sensor at preset time intervals;
determine whether the movement parameters match predetermined reference parameters; and
unlock the electronic device when the movement parameters match predetermined reference parameters.

8. The electronic device according to claim 7, the processor further controls the display device and the motion sensor to enter the sleep mode, when time since activation of the motion sensor is greater than a preset time period.

9. The electronic device according to claim 7, wherein the motion sensor is a gyroscope sensor, and the movement parameters comprise one or more rotation angles of the electronic device based on a predetermined coordinate system of the electronic device.

10. The electronic device according to claim 7, wherein the step of determining whether the movement parameters match predetermined reference parameters comprises:
comparing each of the one or more rotation angles with a corresponding predetermined reference angle on an axis of the predetermined coordinate system; and
determining that the movement parameters match the predetermined reference parameters when each of the one or more rotation angles is greater than the corresponding predetermined reference angle.

11. The electronic device according to claim 7, wherein the motion sensor is an accelerometer, and the movement parameters comprise a distance between a start point and an end point of a movement path of the electronic device, the movement path being determined in response to the spatial moving operation of the electronic device.

12. The electronic device according to claim 11 wherein the step of determining whether the movement parameters match predetermined reference parameters comprises:
comparing the distance with a predetermined reference distance; and
determining that the movement parameters match the predetermined reference parameters when the distance is greater than the predetermined reference distance.

13. A non-transitory storage medium having stored thereon instructions that, when executed by a processor of an electronic device, causes the electronic device to perform a method for controlling access to the electronic device, the electronic device further comprising a motion sensor, a display device, and a storage device, the method comprising:
activating the motion sensor to detect movement parameters of a spatial moving operation of the electronic device, when the display device awakes from a sleep mode;
obtaining the movement parameters from the motion sensor at preset time intervals;
determining whether the movement parameters match predetermined reference parameters; and
unlocking the electronic device when the movement parameters match predetermined reference parameters.

14. The non-transitory storage medium according to claim 13, further comprising:
controlling the display device and the motion sensor to enter the sleep mode, when time since activation of the motion sensor is greater than a preset time period.

15. The non-transitory storage medium according to claim 13, wherein the motion sensor is a gyroscope sensor, and the movement parameters comprise one or more rotation angles of the electronic device based on a predetermined coordinate system of the electronic device.

16. The non-transitory storage medium according to claim 13, wherein the step of determining whether the movement parameters match predetermined reference parameters comprises:
comparing each of the one or more rotation angles with a corresponding predetermined reference angle on an axis of the predetermined coordinate system; and
determining that the movement parameters match the predetermined reference parameters when each of the one or more rotation angles is greater than the corresponding predetermined reference angle.

17. The non-transitory storage medium e according to claim 13, wherein the motion sensor is an accelerometer, and the movement parameters comprise a distance between a start point and an end point of a movement path of the electronic device, the movement path being determined in response to the spatial moving operation of the electronic device.

18. The non-transitory storage medium according to claim 17 wherein the step of determining whether the movement parameters match predetermined reference parameters comprises:
comparing the distance with a predetermined reference distance; and
determining that the movement parameters match the predetermined reference parameters when the distance is greater than the predetermined reference distance.
